(19) United States
(12) Patent Application Publication
(10) Pub. No.: US 2024/0378487 A1
(43) Pub. Date: Nov. 14, 2024

(54) GUIDED TRAINING DATA COLLECTION FOR MACHINE LEARNING

(71) Applicant: GM Global Technology Operations LLC, Detroit, MI (US)

(72) Inventors: Chuan Li, Troy, MI (US); Fan Bai, Ann Arbor, MI (US); Wardah Jaleel Khan, Bloomfield Hills, MI (US); Douglas C. Martin, Goodrich, MI (US)

(21) Appl. No.: 18/313,636

(22) Filed: May 8, 2023

(51) Int. Cl. G06N 20/00

(52) U.S. Cl. CPC G06N 20/00

(57) ABSTRACT

A method for training a machine learning algorithm includes performing at least one exploratory training session of the machine learning algorithm using an input data set. The input data set includes a first plurality of input data samples. The method further includes dividing the input data set into a plurality of input data categories. The method further includes determining a regression curve equation for each of the plurality of input data categories based at least in part on the at least one exploratory training session. The method further includes collecting a second plurality of input data samples based at least in part on the regression curve equation for each of the plurality of input data categories. The method further includes training the machine learning algorithm using the second plurality of input data samples and the input data set.

### INTRODUCTION

The present disclosure relates to systems and methods for training machine learning algorithms.

To increase occupant awareness and convenience, vehicles may be equipped with driver assistance systems and/or automated driving systems. Driver assistance systems may use inputs from multiple vehicle sensors to determine information about an environment surrounding the vehicle and determine suggested or optimal behaviors for the vehicle and/or the occupant. In order to determine information about complex environments in dynamic conditions with large amounts of input sensor data, driver assistance systems may utilize machine learning algorithms which take inputs from the vehicle sensors and determine suggested or optimal behaviors. However, machine learning algorithms must be trained using a large amount of input data. Gathering input data may require additional time and/or resources. Additionally, in order to optimally train machine learning algorithms, specific types or categories of training data having specific characteristics may be required.

Thus, while current machine learning algorithms for vehicles achieve their intended purpose, there is a need for a new and improved system and method for training a machine learning algorithm for a vehicle.

### SUMMARY

According to several aspects, a method for training a machine learning algorithm is provided. The method includes performing at least one exploratory training session of the machine learning algorithm using an input data set. The input data set includes a first plurality of input data samples. The method further includes dividing the input data set into a plurality of input data categories. The method further includes determining a regression curve equation for each of the plurality of input data categories based at least in part on the at least one exploratory training session. The method further includes collecting a second plurality of input data samples based at least in part on the regression curve equation for each of the plurality of input data categories. The method further includes training the machine learning algorithm using the second plurality of input data samples and the input data set.

In another aspect of the present disclosure, dividing the input data set into the plurality of input data categories further may include identifying at least one data set parameter by which to categorize the input data set. Dividing the input data set into the plurality of input data categories further may include dividing the input data set into the plurality of input data categories based on the at least one data set parameter.

In another aspect of the present disclosure, determining the regression curve equation for each of the plurality of input data categories further may include generating an exploratory learning curve plot of a model loss of the machine learning algorithm versus a quantity of input data samples trained for each of the plurality of input data categories in the at least one exploratory training session. Determining the regression curve equation for each of the plurality of input data categories further may include determining the regression curve equation for each of the plurality of input data categories based at least in part on the exploratory learning curve plot for each of the plurality of input data categories.

In another aspect of the present disclosure, determining the regression curve equation for each of the plurality of input data categories further may include determining the regression curve equation for each of the plurality of input data categories based at least in part on the exploratory learning curve plot for each of the plurality of input data categories. The regression curve equation for one of the plurality of input data categories is a power law equation having a form:

$$ε ( m ) = α {m}^{{β}_{g}} + γ$$

where ε is the model loss of the machine learning algorithm for the one of the plurality of input data categories, α is a first constant factor for the one of the plurality of input data categories, m is a quantity of input data samples trained for the one of the plurality of input data categories, β_{g} is a steepness of a regression curve described by the regression curve equation for the one of the plurality of input data categories, and γ is a lower bound model loss of the machine learning algorithm for the one of the plurality of input data categories.

In another aspect of the present disclosure, collecting the second plurality of input data samples further may include identifying a first subset of the plurality of input data categories based at least in part on a quantity of input data samples in each of the plurality of input data categories. Collecting the second plurality of input data samples further may include determining a plurality of data collection quotas based at least in part on the regression curve equation for each of the plurality of input data categories. Each of the plurality of data collection quotas corresponds to one of the first subset of the plurality of input data categories. Collecting the second plurality of input data samples further may include collecting a second plurality of input data samples based at least in part on the plurality of data collection quotas.

In another aspect of the present disclosure, identifying the first subset of the plurality of input data categories further may include comparing a quantity of input data samples in each of the plurality of input data categories to a previous data collection quota. The previous data collection quota is one of the plurality of data collection quotas determined during a previous execution of the method. Identifying the first subset of the plurality of input data categories further may include determining each of the plurality of input data categories having a quantity of input data samples less than the previous data collection quota to be one of the first subset of the plurality of input data categories.

In another aspect of the present disclosure, determining one of the plurality of data collection quotas corresponding to one of the first subset of the plurality of input data categories further may include identifying a second subset of the plurality of input data categories. The second subset of the plurality of input data categories includes each of the plurality of input data categories not in the first subset of the plurality of input data categories. Determining one of the plurality of data collection quotas corresponding to one of the first subset of the plurality of input data categories further may include determining an average steepness β̅_̅{̅g̅}̅ of the regression curve equation for each of the second subset of the plurality of input data categories based at least in part on the regression curve equation of each of the second subset of the plurality of input data categories. Determining one of the plurality of data collection quotas corresponding to one of the first subset of the plurality of input data categories further may include determining a constant factor α′ and a lower bound model loss γ′ of the one of the first subset of the plurality of input data categories based at least in part on the regression curve equation of the one of the first subset of the plurality of input data categories. Determining one of the plurality of data collection quotas corresponding to one of the first subset of the plurality of input data categories further may include determining the one of the plurality of data collection quotas using a predetermined equation based at least in part on the average steepness β̅_̅{̅g̅}̅, the constant factor α′ and the lower bound model loss γ′.

In another aspect of the present disclosure, determining the one of the plurality of data collection quotas using the predetermined equation further may include determining the one of the plurality of data collection quotas using the predetermined equation. The predetermined equation includes:

$${m}_{i + 1} = {[ \frac{0.5 ε ( {m}_{i} ) - {γ}^{′}}{{α}^{′}} ]}^{{( \overline{{β}_{g}} )}^{- 1}}$$

where mᵢ₊₁ is the one of the plurality of data collection quotas, mᵢ is a quantity of input data samples in the one of the first subset of the plurality of input data categories, α′ is a first constant factor of the one of the first subset of the plurality of input data categories, γ′ is a lower bound model loss of the one of the first subset of the plurality of input data categories, and β̅_̅{̅g̅}̅ is the average steepness of the regression curve equation for each of the second subset of the plurality of input data categories.

In another aspect of the present disclosure, collecting the second plurality of input data samples further may include determining a quantity of additional input data samples to collect for each of the first subset of the plurality of input data categories using an equation:

$$s = {m}_{i + 1} - {m}_{i}$$

where s is the quantity of additional input data samples to collect for the one of the first subset of the plurality of input data categories, mᵢ₊₁ is the one of the plurality of data collection quotas for the one of the first subset of the plurality of input data categories, and mᵢ is the quantity of input data samples in the one of the first subset of the plurality of input data categories. Collecting the second plurality of input data samples further may include transmitting a data sample collection task to a vehicle. The data sample collection task includes at least the quantity of additional input data samples to collect for each of the first subset of the plurality of input data categories.

In another aspect of the present disclosure, training the machine learning algorithm using the second plurality of input data samples and the input data set further may include receiving the second plurality of input data samples from the vehicle. Training the machine learning algorithm using the second plurality of input data samples and the input data set further may include generating an updated input data set. The updated input data set includes the second plurality of input data samples and the input data set. Training the machine learning algorithm using the second plurality of input data samples and the input data set further may include performing the method using the updated input data set.

According to several aspects, a system for training a machine learning algorithm for a vehicle is provided. The system includes a server system including a server storage device, a server communication system, and a server controller in electrical communication with the server storage device and the server communication system. The server controller is programmed to perform at least one exploratory training session of the machine learning algorithm using an input data set. The input data set includes a first plurality of input data samples. The input data set is stored on the server storage device. The server controller is further programmed to divide the input data set into a plurality of input data categories. The server controller is further programmed to generate an exploratory learning curve plot of a model loss of the machine learning algorithm versus a quantity of input data samples trained for each of the plurality of input data categories in the at least one exploratory training session. The server controller is further programmed to determine a regression curve equation for each of the plurality of input data categories based at least in part on the exploratory learning curve plot for each of the plurality of input data categories. The regression curve equation for one of the plurality of input data categories is a power law equation having a form:

$$ε ( m ) = α {m}^{{β}_{g}} + γ$$

where ε is the model loss of the machine learning algorithm for the one of the plurality of input data categories, α is a first constant factor for the one of the plurality of input data categories, m is a quantity of input data samples trained for the one of the plurality of input data categories, β_{g} is a steepness of a regression curve described by the regression curve equation for the one of the plurality of input data categories, and γ is a lower bound model loss of the machine learning algorithm for the one of the plurality of input data categories. The server controller is further programmed to collect a second plurality of input data samples from the vehicle using the server communication system. The second plurality of input data samples is based at least in part on the regression curve equation for each of the plurality of input data categories. The server controller is further programmed to train the machine learning algorithm using the second plurality of input data samples and the input data set.

In another aspect of the present disclosure, to collect the second plurality of input data samples from the vehicle using the server communication system, the server controller is further programmed to identify a first subset of the plurality of input data categories based at least in part on a quantity of input data samples in each of the plurality of input data categories. To collect the second plurality of input data samples from the vehicle using the server communication system, the server controller is further programmed to determine a plurality of data collection quotas based at least in part on the regression curve equation for each of the plurality of input data categories, where each of the plurality of data collection quotas corresponds to one of the first subset of the plurality of input data categories. To collect the second plurality of input data samples from the vehicle using the server communication system, the server controller is further programmed to determine a quantity of additional input data samples to collect for each of the first subset of the plurality of input data categories using an equation:

$$s = {m}_{i + 1} - {m}_{i}$$

wherein s is the quantity of additional input data samples to collect for the one of the first subset of the plurality of input data categories, mᵢ₊₁ is the one of the plurality of data collection quotas for the one of the first subset of the plurality of input data categories, and mᵢ is a quantity of input data samples in the one of the first subset of the plurality of input data categories. To collect the second plurality of input data samples from the vehicle using the server communication system, the server controller is further programmed to transmit a data sample collection task to the vehicle using the server communication system. The data sample collection task includes at least the quantity of additional input data samples to collect for each of the first subset of the plurality of input data categories.

In another aspect of the present disclosure, to determine one of the plurality of data collection quotas corresponding to one of the first subset of the plurality of input data categories, the server controller is further programmed to identify a second subset of the plurality of input data categories. The second subset of the plurality of input data categories includes each of the plurality of input data categories not in the first subset of the plurality of input data categories. To determine one of the plurality of data collection quotas corresponding to one of the first subset of the plurality of input data categories, the server controller is further programmed to determine an average steepness β̅_̅{̅g̅}̅ of the regression curve equation for each of the second subset of the plurality of input data categories based at least in part on the regression curve equation of each of the second subset of the plurality of input data categories. To determine one of the plurality of data collection quotas corresponding to one of the first subset of the plurality of input data categories, the server controller is further programmed to determine a constant factor α′ and a lower bound model loss γ′ of the one of the first subset of the plurality of input data categories based at least in part on the regression curve equation of the one of the first subset of the plurality of input data categories. To determine one of the plurality of data collection quotas corresponding to one of the first subset of the plurality of input data categories, the server controller is further programmed to determine the one of the plurality of data collection quotas using a predetermined equation based at least in part on the average steepness β̅_̅{̅g̅}̅, the constant factor α′ and the lower bound model loss γ′.

In another aspect of the present disclosure, to determine the one of the plurality of data collection quotas using the predetermined equation, the server controller is further programmed to determine the one of the plurality of data collection quotas using the predetermined equation. The predetermined equation includes:

$${m}_{i + 1} = {[ \frac{0.5 ε ( {m}_{i} ) - {γ}^{′}}{{α}^{′}} ]}^{{( \overline{{β}_{g}} )}^{- 1}}$$

where mᵢ₊₁ is the one of the plurality of data collection quotas, mᵢ is a quantity of input data samples in the one of the first subset of the plurality of input data categories, α′ is the constant factor of the one of the first subset of the plurality of input data categories, γ′ is the lower bound model loss of the one of the first subset of the plurality of input data categories, and β̅_̅{̅g̅}̅ is the average steepness of the regression curve equation for each of the second subset of the plurality of input data categories.

In another aspect of the present disclosure, to transmit the data sample collection task to the vehicle using the server communication system, the server controller is further programmed to transmit the data sample collection task to the vehicle using the server communication system. The data sample collection task includes a validation algorithm describing one of the plurality of input data categories and at least one of a task priority, a projected decrease in model loss, and the quantity of additional input data samples to collect.

In another aspect of the present disclosure, the system further includes a vehicle system including at least one vehicle sensor, a vehicle communication system, and a vehicle controller in electrical communication with the at least one vehicle sensor and the vehicle communication system. The vehicle controller is programmed to receive the data sample collection task from the server system using the vehicle communication system. The vehicle controller is further programmed to determine a priority of the data sample collection task based at least in part on at least one of the task priority, the projected decrease in model loss, and the quantity of additional input data samples to collect. The vehicle controller is further programmed to perform the data sample collection task using the at least one vehicle sensor.

In another aspect of the present disclosure, to perform the data sample collection task, the vehicle controller is further programmed to record a plurality of unvalidated input data samples using the at least one vehicle sensor. To perform the data sample collection task, the vehicle controller is further programmed to determine a second plurality of input data samples based at least in part on the validation algorithm. The second plurality of input data samples is a subset of the plurality of unvalidated input data samples. To perform the data sample collection task, the vehicle controller is further programmed to transmit the second plurality of input data samples to the server communication system using the vehicle communication system.

According to several aspects, a method for training a machine learning algorithm for a vehicle is provided. The method includes performing at least one exploratory training session of the machine learning algorithm using an input data set. The input data set includes a first plurality of input data samples. The input data set is stored on a server storage device. The method also includes dividing the input data set into a plurality of input data categories. The method also includes generating an exploratory learning curve plot of a model loss of the machine learning algorithm versus a quantity of input data samples trained for each of the plurality of input data categories in the at least one exploratory training session. The method also includes determining a regression curve equation for each of the plurality of input data categories based at least in part on the exploratory learning curve plot for each of the plurality of input data categories. The regression curve equation for one of the plurality of input data categories is a power law equation having a form:

$$ε ( m ) = α {m}^{{β}_{g}} + γ$$

where ε is the model loss of the machine learning algorithm for the one of the plurality of input data categories, α is a first constant factor for the one of the plurality of input data categories, m is a quantity of input data samples trained for the one of the plurality of input data categories, β_{g} is a steepness of a regression curve described by the regression curve equation for the one of the plurality of input data categories, and γ is a lower bound model loss of the machine learning algorithm for the one of the plurality of input data categories. The method also includes transmitting a data sample collection task to a vehicle communication system of the vehicle using a server communication system. The method also includes receiving the data sample collection task using a vehicle communication system. The method also includes collecting a second plurality of input data samples using at least one vehicle sensor. The second plurality of input data samples is based at least in part on the regression curve equation for each of the plurality of input data categories. The method also includes transmitting the second plurality of input data samples from the vehicle communication system to the server communication system. The method also includes training the machine learning algorithm using the second plurality of input data samples received from the vehicle communication system and the input data set.

In another aspect of the present disclosure, collecting the second plurality of input data samples from the vehicle using the server communication system further may include identifying a first subset of the plurality of input data categories based at least in part on a quantity of input data samples in each of the plurality of input data categories. Collecting the second plurality of input data samples from the vehicle using the server communication system further may include determining a plurality of data collection quotas based at least in part on the regression curve equation for each of the plurality of input data categories. Each of the plurality of data collection quotas corresponds to one of the first subset of the plurality of input data categories. Collecting the second plurality of input data samples from the vehicle using the server communication system further may include determining a quantity of additional input data samples to collect for each of the first subset of the plurality of input data categories using an equation:

$$s = {m}_{i + 1} - {m}_{i}$$

where s is the quantity of additional input data samples to collect for the one of the first subset of the plurality of input data categories, mᵢ₊₁ is the one of the plurality of data collection quotas for the one of the first subset of the plurality of input data categories, and mᵢ is a quantity of input data samples in the one of the first subset of the plurality of input data categories. Transmitting the data sample collection task to the vehicle communication system using the server communication system. The data sample collection task includes at least the quantity of additional input data samples to collect for each of the first subset of the plurality of input data categories.

In another aspect of the present disclosure, determining one of the plurality of data collection quotas corresponding to one of the first subset of the plurality of input data categories further may include identifying a second subset of the plurality of input data categories. The second subset of the plurality of input data categories includes each of the plurality of input data categories not in the first subset of the plurality of input data categories. Determining one of the plurality of data collection quotas corresponding to one of the first subset of the plurality of input data categories further may include determining an average steepness β̅_̅{̅g̅}̅ of the regression curve equation for each of the second subset of the plurality of input data categories based at least in part on the regression curve equation of each of the second subset of the plurality of input data categories. Determining one of the plurality of data collection quotas corresponding to one of the first subset of the plurality of input data categories further may include determining a constant factor α′ and a lower bound model loss γ′ of the one of the first subset of the plurality of input data categories based at least in part on the regression curve equation of the one of the first subset of the plurality of input data categories. Determining one of the plurality of data collection quotas corresponding to one of the first subset of the plurality of input data categories further may include and determining the one of the plurality of data collection quotas using a predetermined equation. The predetermined equation includes:

$${m}_{i + 1} = {[ \frac{0.5 ε ( {m}_{i} ) - {γ}^{′}}{{α}^{′}} ]}^{{( \overline{{β}_{g}} )}^{- 1}}$$

wherein mᵢ₊₁ is the one of the plurality of data collection quotas, mᵢ is a quantity of input data samples in the one of the first subset of the plurality of input data categories, α′ is the constant factor of the one of the first subset of the plurality of input data categories, γ′ is the lower bound model loss of the one of the first subset of the plurality of input data categories, and β̅_̅{̅g̅}̅ is the average steepness of the regression curve equation for each of the second subset of the plurality of input data categories.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for training a machine learning algorithm for a vehicle, according to an exemplary embodiment;

FIG. 2 is a flowchart of a method for training a machine learning algorithm, according to an exemplary embodiment; and

FIG. 3 is a flowchart of a method for receiving a data sample collection task and collecting a second plurality of input data samples, according to an exemplary embodiment.

### DETAILED DESCRIPTION

The following description is merely exemplary in nature and is not intended to limit the present disclosure, application, or uses.

Machine learning algorithms find various applications in the contexts of vehicle control, automated driving, driver assistance systems, and the like. Training machine learning algorithms may require large amounts of data. Gathering and/or storing large amounts of data may be resource and/or time intensive. Therefore, the present disclosure provides a new and improved system and method for gathering data for training a machine learning algorithm for a vehicle which allows for optimized data collection based on performance of the machine learning algorithm, reducing training time and/or resources.

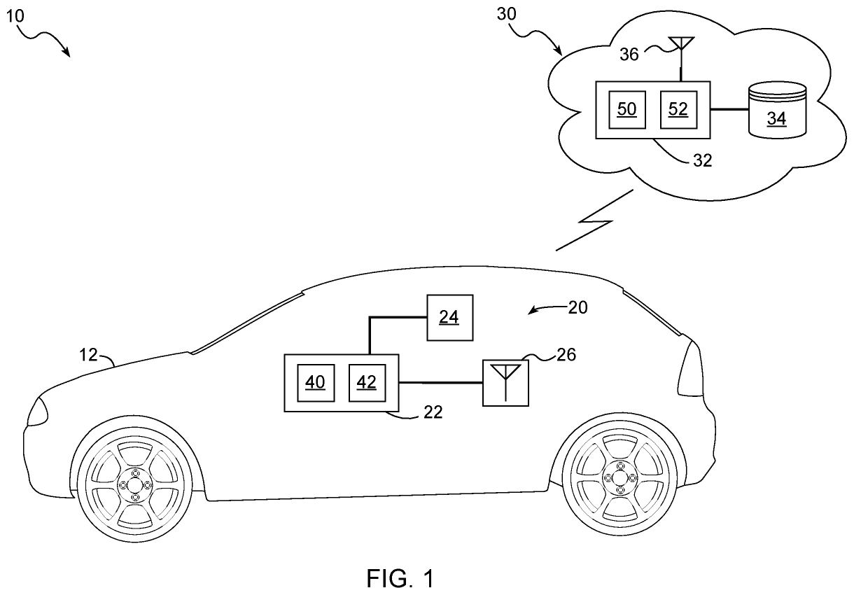

Referring to FIG. 1, a system for training a machine learning algorithm for a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a vehicle system 20 including a vehicle controller 22, at least one vehicle sensor 24, and a vehicle communication system 26. The system 10 further includes a server system 30 including a server controller 32, a server storage device 34, and a server communication system 36.

The vehicle controller 22 is used to implement a method 100 for training a machine learning algorithm, as will be described below. The vehicle controller 22 includes at least one processor 40 and a non-transitory computer readable storage device or media 42. The processor 40 may be a custom made or commercially available processor, a central processing unit (CPU), a graphics processing unit (GPU), an auxiliary processor among several processors associated with the vehicle controller 22, a semiconductor-based microprocessor (in the form of a microchip or chip set), a macroprocessor, a combination thereof, or generally a device for executing instructions. The computer readable storage device or media 42 may include volatile and nonvolatile storage in read-only memory (ROM), random-access memory (RAM), and keep-alive memory (KAM), for example. KAM is a persistent or non-volatile memory that may be used to store various operating variables while the processor 40 is powered down. The computer-readable storage device or media 42 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the vehicle controller 22 to control various systems of the vehicle 12. The vehicle controller 22 may also consist of multiple controllers which are in electrical communication with each other. The vehicle controller 22 may be inter-connected with additional systems and/or controllers of the vehicle 12, allowing the vehicle controller 22 to access data such as, for example, speed, acceleration, braking, and steering angle of the vehicle 12.

The vehicle controller 22 is in electrical communication with the at least one vehicle sensor 24 and the vehicle communication system 26. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the vehicle controller 22 are within the scope of the present disclosure.

The at least one vehicle sensor 24 is used to determine performance data about the vehicle 12. In an exemplary embodiment, the at least one vehicle sensor 24 includes at least one of a motor speed sensor, a motor torque sensor, an electric drive motor voltage and/or current sensor, an accelerator pedal position sensor, a coolant temperature sensor, a cooling fan speed sensor, and a transmission oil temperature sensor. In another exemplary embodiment, the plurality of vehicle sensors further includes sensors to determine information about an environment surrounding the vehicle 12, for example, an ambient air temperature sensor, a barometric pressure sensor, and/or a photo and/or video camera which is positioned to view the environment in front of the vehicle 12. In another exemplary embodiment, at least one of the at least one vehicle sensor 24 is capable of measuring distances in the environment surrounding the vehicle 12. In a non-limiting example wherein the at least one vehicle sensor 24 includes a camera, the at least one vehicle sensor 24 measures distances using an image processing algorithm configured to process images from the camera and determine distances between objects. In another non-limiting example, the at least one vehicle sensor 24 includes a stereoscopic camera having distance measurement capabilities. In one example, at least one of the at least one vehicle sensor 24 is affixed inside of the vehicle 12, for example, in a headliner of the vehicle 12, having a view through a windscreen of the vehicle 12. In another example, at least one of the at least one vehicle sensor 24 is affixed outside of the vehicle 12, for example, on a roof of the vehicle 12, having a view of the environment surrounding the vehicle 12. It should be understood that various additional types of vehicle sensors, such as, for example, LiDAR sensors, ultrasonic ranging sensors, radar sensors, and/or time-of-flight sensors are within the scope of the present disclosure.

The vehicle communication system 26 is used by the controller 14 to communicate with other systems external to the vehicle 12. For example, the vehicle communication system 26 includes capabilities for communication with vehicles (“V2V” communication), infrastructure (“V2I” communication), remote systems at a remote call center (e.g., ON-STAR by GENERAL MOTORS) and/or personal devices. In general, the term vehicle-to-everything communication (“V2X” communication) refers to communication between the vehicle 12 and any remote system (e.g., vehicles, infrastructure, and/or remote systems). In certain embodiments, the vehicle communication system 26 is a wireless communication system configured to communicate via a wireless local area network (WLAN) using IEEE 802.11 standards or by using cellular data communication (e.g., using GSMA standards, such as, for example, SGP.02, SGP.22, SGP.32, and the like). Accordingly, the vehicle communication system 26 may further include an embedded universal integrated circuit card (eUICC) configured to store at least one cellular connectivity configuration profile, for example, an embedded subscriber identity module (eSIM) profile. The vehicle communication system 26 is further configured to communicate via a personal area network (e.g., BLUETOOTH) and/or near-field communication (NFC). However, additional or alternate communication methods, such as a dedicated short-range communications (DSRC) channel and/or mobile telecommunications protocols based on the 3^{rd} Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure. Accordingly, the vehicle communication system 26 may include one or more antennas and/or communication transceivers for receiving and/or transmitting signals, such as cooperative sensing messages (CSMs). The vehicle communication system 26 is configured to wirelessly communicate information between the vehicle 12 and another vehicle. Further, the vehicle communication system 26 is configured to wirelessly communicate information between the vehicle 12 and infrastructure or other vehicles. It should be understood that the vehicle communication system 26 may be integrated with the controller 14 (e.g., on a same circuit board with the controller 14 or otherwise a part of the controller 14) without departing from the scope of the present disclosure.

With continued reference to FIG. 1, the server system is illustrated and generally indicated by reference number 30. The server system 30 includes the server controller 32 in electrical communication with the server storage device 34 and the server communication system 36. In a non-limiting example, the server system 30 is located in a server farm, datacenter, or the like, and connected to the internet. The server controller 32 is used to implement the method 100 for training the machine learning algorithm, as will be described below. The server controller 32 includes at least one server processor 50 and a server non-transitory computer readable storage device or server media 52. The description of the type and configuration given above for the vehicle controller 22 also applies to the server controller 32. In a non-limiting example, the server processor 50 and server media 52 of the server controller 32 are similar in structure and/or function to the processor 40 and the media 42 of the vehicle controller 22, as described above. The server communication system 36 is used to communicate with external systems, such as, for example, the vehicle controller 22 via the vehicle communication system 26. In a non-limiting example, server communication system 36 is similar in structure and/or function to the vehicle communication system 26 of the vehicle system 20, as described above.

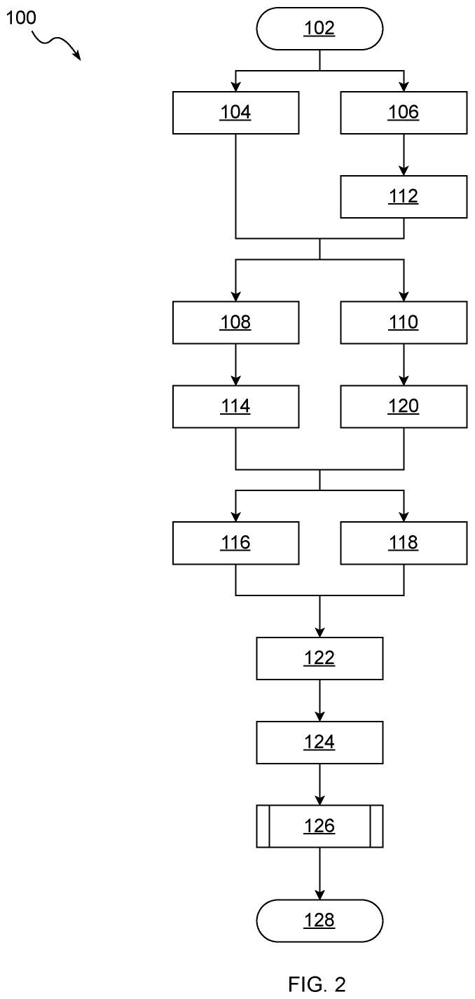

Referring to FIG. 2, a flowchart of the method 100 for training a machine learning algorithm is shown. The method 100 begins at block 102 and proceeds to blocks 104 and 106. At block 104, the server controller 32 performs at least one exploratory training session of a machine learning algorithm. In the scope of the present disclosure, the machine learning algorithm may be any type of supervised learning algorithm (i.e., a type of machine learning algorithm which learns to make predictions or classifications based on labeled input data), such as, for example, a computer vision (CV) machine learning algorithm, a language processing machine learning algorithm, and/or the like. In the scope of the present disclosure, the at least one exploratory training session involves training the machine learning algorithm with an input data set. In a non-limiting example, the input data set includes a first plurality of input data samples. In the scope of the present disclosure, an input data sample is a training sample (e.g., an image of a road sign) and an accompanying label for the training sample (e.g., a “stop sign” classification label). One or more exploratory training sessions may be performed in order to determine the accuracy of the machine learning algorithm, as will be discussed in greater detail below. After block 104, the method 100 proceeds to blocks 108 and 110, as will be discussed in greater detail below.

At block 106, the server controller 32 identifies at least one data set parameter by which to categorize the input data set. In an exemplary embodiment, the at least one data set parameter is a parameter which may vary between individual input data samples. In a non-limiting example, wherein the input data set includes images of traffic signals, the at least one data set parameter includes one or more of an environmental light level, a traffic signal phase (i.e., traffic signal color), a weather condition (i.e., clear, fog, rain, and/or the like), a distance between the vehicle and the traffic signal, and/or the like. In an exemplary embodiment, the at least one data set parameter by which to categorize the input data set is predetermined and saved in the server storage device 34 for retrieval by the server controller 32. In another exemplary embodiment, the server controller 32 determines the at least one data set parameter by random selection. After block 106, the method 100 proceeds to block 112.

At block 112, the server controller 32 divides the input data set into a plurality of input data categories based on the at least one data set parameter identified at block 106. In an exemplary embodiment, each of the plurality of input data categories includes a subset of the first plurality of input data samples of the input data set. In a non-limiting example, one of the plurality of input data categories is “low environment light”. Therefore, the relevant data set parameter is “environmental light”, and the input data category “low environment light” includes a subset of the first plurality of input data samples of the input data set having an environment light below a predetermined environment light threshold. Accordingly, at block 112, each of the first plurality of input data samples of the input data set is labeled as being a member of one of the plurality of input data categories, and this information is saved in the server storage device 34. After block 112, the method 100 proceeds to blocks 108 and 110.

At block 108, the server controller 32 generates an exploratory learning curve plot for each of the plurality of input data categories determined at block 112 based on the at least one exploratory training session performed at block 104. In the scope of the present disclosure, a learning curve plot is a plot of a model loss of the machine learning algorithm versus a quantity of input data samples trained in the at least one exploratory training session. In the scope of the present disclosure, the model loss of the machine learning algorithm represents a difference between a predicted output of the machine learning algorithm and an actual output for a given input data sample. At block 108, the server controller 32 generates a plurality of exploratory learning curve plots, one for each of the plurality of input data categories. Therefore, the plurality of exploratory learning curve plots describe a learning curve for each of the plurality of input data categories after the at least one exploratory training session. After block 108, the method 100 proceeds to block 114.

At block 114, the server controller 32 determines a regression curve equation for each of the plurality of input data categories. In the scope of the present disclosure, the regression curve equation is a mathematical expression which represents a relationship between a dependent variable (i.e., the model loss) and an independent variable (i.e., the quantity of input data samples trained). In an exemplary embodiment, the server controller 32 first determines a mathematical model for the regression curve equation. In a non-limiting example, mathematical model is predetermined to be a power law equation having a form:

$$ε ( m ) = α {m}^{{β}_{g}} + γ \qquad ( 1 )$$

wherein ε is the model loss of the machine learning algorithm for one of the plurality of input data categories, α is a first constant factor for the one of the plurality of input data categories, m is a quantity of input data samples trained for the one of the plurality of input data categories, β_{g} is a steepness of a regression curve described by the regression curve equation for the one of the plurality of input data categories, and γ is a lower bound model loss of the machine learning algorithm (i.e., a second constant factor) for the one of the plurality of input data categories.

In an exemplary embodiment, to determine the regression curve equation for each of the plurality of input data categories, the server controller 32 uses a curve fitting method on each of the plurality of exploratory learning curve plots determined at block 108 to fit each of the plurality of exploratory learning curve plots to the regression curve equation (1) described above. In an exemplary embodiment, the curve fitting method is configured to find a tuple (α, β_{g}, γ) for each of the plurality of input data categories which minimizes curve fitting error between the regression curve described by the regression curve equation (1) and the exploratory learning curve plot for each of the plurality of input data categories. In a non-limiting example, the curve fitting method includes at least one of: the least squares method, the maximum likelihood method, and the Bayesian inference method. It should be understood that additional methods for determining a mathematical expression which represents a relationship between the model loss and the quantity of input data samples trained based on the plurality of exploratory learning curve plots are within the scope of the present disclosure. After block 114, the method 100 proceeds to blocks 116 and 118 as will be discussed in greater detail below.

At block 110, the controller 14 identifies a first subset of the plurality of input data categories. In an exemplary embodiment, the first subset of the plurality of input data categories includes input data categories for which enough input data samples have not yet been collected. Upon an initial execution of the method 100, to determine the first subset of the plurality of input data categories, the server controller 32 compares a quantity of input data samples in each of the plurality of input data categories to a predetermined sample quantity threshold (e.g., one hundred samples). If the quantity of input data samples in a given one of the plurality of input data categories is less than the sample quantity threshold, the given one of the plurality of input data categories is determined to be included in the first subset of the plurality of input data categories. As will be discussed in greater detail below, the method 100 may be repeatedly executed, with some or all data from previous executions of the method 100 being stored persistently in the server storage device 34. Upon subsequent executions of the method 100, the server controller 32 compares the quantity of input data samples in each of the plurality of input data categories to a previous data collection quota. The previous data collection quota is a data collection quota determined during a previous execution of the method 100 and stored in the server storage device 34. The data collection quota will be defined and discussed in further detail below. If the quantity of input data samples in a given one of the plurality of input data categories is less than the previous data collection quota, the given one of the plurality of input data categories is determined to be included in the first subset of the plurality of input data categories. After block 110, the method 100 proceeds to block 120.

At block 120, the server controller 32 identifies a second subset of the plurality of input data categories. In an exemplary embodiment, the second subset of the plurality of input data categories includes input data categories for which enough input data samples have been collected. In an exemplary embodiment, the second subset of the plurality of input data categories includes each of the plurality of input data categories not in the first subset of the plurality of input data categories as determined at block 110. After block 120, the method 100 proceeds to blocks 116 and 118.

At block 116, the server controller 32 determines an average steepness β̅_̅{̅g̅}̅ of the plurality of regression curve equations corresponding to each of the second subset of the plurality of input data categories. In other words, the average steepness β̅_̅{̅g̅}̅ is the average (i.e., arithmetic mean) of the plurality of steepness values β_{g} (determined at block 114) for input data categories for which enough input data samples have been collected (i.e., the second subset of the plurality of input data categories). After block 116, the method 100 proceeds to block 122 as will be discussed in greater detail below.

At block 118, the server controller 32 determines a constant factor α′ and a lower bound model loss γ′ of each of the first subset of the plurality of input data categories based on the plurality of regression curve equations corresponding to each of the first subset of the plurality of input data categories determined at block 114. After block 118, the method 100 proceeds to block 122.

At block 122, the server controller 32 determines a plurality of data collection quotas, wherein each of the plurality of data collection quotas corresponds to one of the first subset of the plurality of input data categories. In the scope of the present disclosure, a data collection quota for a given input data category is a total number of input data samples for the given input data category which will result in a reduction of the model loss for the given input data category by a predetermined loss reduction amount (e.g., fifty percent) upon further training. In an exemplary embodiment, each of the plurality of data collection quotas is determined using a predetermined equation:

$${m}_{i + 1} = {[ \frac{0.5 ε ( {m}_{i} ) - {γ}^{′}}{{α}^{′}} ]}^{{( \overline{{β}_{g}} )}^{- 1}} \qquad ( 2 )$$

wherein mᵢ₊₁ is one of the plurality of data collection quotas, mᵢ is the quantity of input data samples in the one of the first subset of the plurality of input data categories, α′ is the constant factor of the one of the first subset of the plurality of input data categories as determined at block 118, γ′ is the lower bound model loss of the one of the first subset of the plurality of input data categories as determined at block 118, and β̅_̅{̅g̅}̅ is the average steepness of the regression curve equation for each of the second subset of the plurality of input data categories as determined at block 116. Therefore, it should be understood that to reduce the model loss by half for a given one of the first subset of input data categories, a quantity of additional input data samples should be collected for the given one of the first subset of input data categories:

$$s = {m}_{i + 1} - {m}_{i} \qquad ( 3 )$$

wherein s is the quantity of additional input data samples to collect for one of the first subset of the plurality of input data categories, mᵢ₊₁ is the one of the plurality of data collection quotas for the one of the first subset of the plurality of input data categories, and mᵢ is the quantity of input data samples in the one of the first subset of the plurality of input data categories. Accordingly, after completion of block 122, the method 100 has computed a quantity of additional input data samples to collect for each of the first subset of the plurality of input data categories in order to reduce the model loss of each of the first subset of the plurality of input data categories by half. It should be understood that by collecting the additional input data samples (as will be discussed in greater detail below) and repeatedly executing the method 100, the model loss will be iteratively decreased. After block 122, the method 100 proceeds to block 124.

At block 124, the server controller 32 uses the server communication system 36 to transmit a data sample collection task for each of the first subset of the plurality of input data categories to the vehicle 12. In the scope of the present disclosure, the data sample collection task is a message containing information for the vehicle controller 22 to enable collection of the additional input data samples. In an exemplary embodiment, the data sample collection task includes a validation algorithm describing one of the plurality of input data categories, a task priority (i.e., an indication of a priority level of the data sample collection task relative to other data sample collection tasks), a projected decrease in model loss (e.g., determined by extrapolation of the regression curve equation), the quantity of additional input data samples to collect, a task identifier (i.e., a numeric code which uniquely identifies the data sample collection task), and a sensor identifier (i.e., a numeric code which uniquely identifies which of the at least one vehicle sensors 24 should be used for data collection).

In the scope of the present disclosure, the validation algorithm is a mathematical, logical, programmatic, or similar algorithm which is configured to determine whether a particular collected data sample falls into a desired one of the plurality of input data categories. In a non-limiting example, the validation algorithm is a simple logical statement such as, for example, “if light_level is greater than 200, then true, otherwise, false”. In the above example, the validation algorithm would result in selection of only input data having a light level greater than two hundred. In other examples, the validation algorithm may be a more complex construction, such as, for example, a series of nested logical statements, a set of computer-executable instructions (i.e., a computer program or script), or a mathematical function. The validation algorithm will be discussed in further detail below. It should be understood that the data sample collection task may include additional information and/or omit portions of the above information without departing from the scope of the present disclosure. After block 124, the method 100 proceeds to block 126.

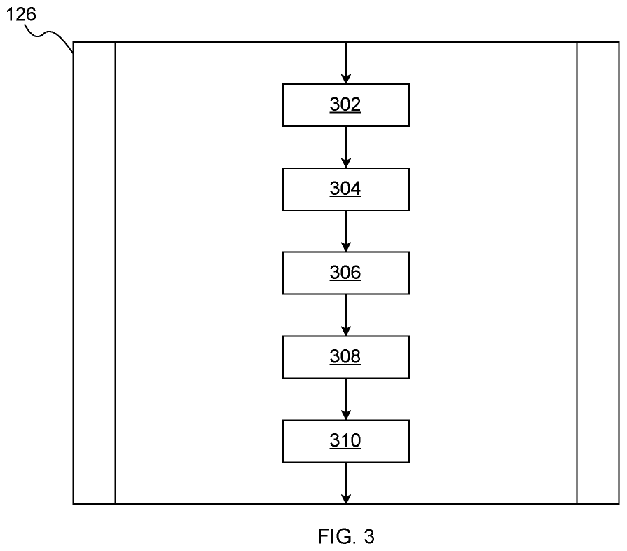

At block 126, the vehicle 12 receives the data sample collection tasks transmitted at block 124 and collects a second plurality of input data samples, as will be discussed in greater detail in reference to FIG. 3 below. After block 126, the method 100 proceeds to enter a standby state at block 128.

In an exemplary embodiment, the server controller 32 repeatedly exits the standby state 128 and restarts the method 100 at block 102. In a non-limiting example, the server controller 32 exits the standby state 128 and restarts the method 100 on a timer, for example, every three hundred milliseconds. By repeatedly performing the method 100, the model loss for each of the first subset of the plurality of input data categories is iteratively decreased.

Referring to FIG. 3, a flowchart of an exemplary embodiment of block 126 is shown. The exemplary embodiment of block 126 begins at block 302. At block 302, the vehicle communication system 26 receives the plurality of data sample collection tasks from the server system 30. In an exemplary embodiment, the plurality of received data sample collection tasks are stored in the media 42 of the vehicle controller 22. After block 302, the exemplary embodiment of block 126 proceeds to block 304.

At block 304, the vehicle controller 22 determines a priority of each of the plurality of data sample collection tasks received at block 302. In an exemplary embodiment, the priority is determined based on the task priority of each of the plurality of data sample collection tasks. In examples where multiple data sample collection tasks have an equal task priority, the projected decrease in model loss and/or the quantity of additional input data samples to collect are used to determine the priority of each of the plurality of data sample collection tasks. After block 304, the exemplary embodiment of block 126 proceeds to block 306.

At block 306, the vehicle controller 22 uses the at least one vehicle sensor 24 to record a plurality of unvalidated input data samples. In the scope of the present disclosure, unvalidated input data samples are input data samples recorded by the at least one vehicle sensor 24, but which may not necessarily correspond to any of the first subset of the plurality of input data categories. After block 306, the exemplary embodiment of block 126 proceeds to block 308.

At block 308, the vehicle controller 22 uses the validation algorithm, as discussed above, to determine the second plurality of input data samples. In the scope of the present disclosure, the second plurality of input data samples is a subset of the plurality of unvalidated input data samples for which the validation algorithm of at least one of the plurality of data sample collection tasks returned a true value. In other words, the validation algorithms of each of the plurality of data sample collection tasks are executed with the plurality of unvalidated input data samples as inputs. The subset of the plurality of unvalidated input data samples for which at least one of the validation algorithms of each of the plurality of data sample collection tasks returns “true” is considered to be the second plurality of input data samples. After block 308, the exemplary embodiment of block 126 proceeds to block 310.

At block 310, the vehicle controller 22 uses the vehicle communication system 26 to transmit the second plurality of input data samples determined at block 308 to the server communication system 36. In an exemplary embodiment, after receiving the second plurality of input data samples, the server system 30 adds the second plurality of input data samples to the input data set discussed above, generating an updated input data set. The method 100 is then repeated with the updated input data set. After block 310, the exemplary embodiment of block 126 is concluded, and the method 100 continues as discussed above.

The system 10 and method 100 of the present disclosure offer several advantages. The system 10 allows for communication between the vehicle system 20 and the server system 30 to optimize data collection for training of the machine learning algorithm. Using the method 100, characteristics of the training data gathered by the vehicle system 20 are adjusted based on the performance of the machine learning algorithm, resulting in reduced training time and reduced resource use.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for training a machine learning algorithm, the method comprising:
performing at least one exploratory training session of the machine learning algorithm using an input data set, wherein the input data set includes a first plurality of input data samples;
dividing the input data set into a plurality of input data categories;
determining a regression curve equation for each of the plurality of input data categories based at least in part on the at least one exploratory training session;
collecting a second plurality of input data samples based at least in part on the regression curve equation for each of the plurality of input data categories; and
training the machine learning algorithm using the second plurality of input data samples and the input data set.

2. The method of claim 1, wherein dividing the input data set into the plurality of input data categories further comprises:
identifying at least one data set parameter by which to categorize the input data set; and
dividing the input data set into the plurality of input data categories based on the at least one data set parameter.

3. The method of claim 1, wherein determining the regression curve equation for each of the plurality of input data categories further comprises:
generating an exploratory learning curve plot of a model loss of the machine learning algorithm versus a quantity of input data samples trained for each of the plurality of input data categories in the at least one exploratory training session; and
determining the regression curve equation for each of the plurality of input data categories based at least in part on the exploratory learning curve plot for each of the plurality of input data categories.

4. The method of claim 3, wherein determining the regression curve equation for each of the plurality of input data categories further comprises:
determining the regression curve equation for each of the plurality of input data categories based at least in part on the exploratory learning curve plot for each of the plurality of input data categories, wherein the regression curve equation for one of the plurality of input data categories is a power law equation having a form:
$$ε ( m ) = α {m}^{{β}_{g}} + γ$$
wherein ε is the model loss of the machine learning algorithm for the one of the plurality of input data categories, α is a first constant factor for the one of the plurality of input data categories, m is a quantity of input data samples trained for the one of the plurality of input data categories, β_{g} is a steepness of a regression curve described by the regression curve equation for the one of the plurality of input data categories, and γ is a lower bound model loss of the machine learning algorithm for the one of the plurality of input data categories.

5. The method of claim 4, wherein collecting the second plurality of input data samples further comprises:
identifying a first subset of the plurality of input data categories based at least in part on a quantity of input data samples in each of the plurality of input data categories;
determining a plurality of data collection quotas based at least in part on the regression curve equation for each of the plurality of input data categories, wherein each of the plurality of data collection quotas corresponds to one of the first subset of the plurality of input data categories; and
collecting a second plurality of input data samples based at least in part on the plurality of data collection quotas.

6. The method of claim 5, wherein identifying the first subset of the plurality of input data categories further comprises:
comparing a quantity of input data samples in each of the plurality of input data categories to a previous data collection quota, wherein the previous data collection quota is one of the plurality of data collection quotas determined during a previous execution of the method; and
determining each of the plurality of input data categories having a quantity of input data samples less than the previous data collection quota to be one of the first subset of the plurality of input data categories.

7. The method of claim 5, wherein determining one of the plurality of data collection quotas corresponding to one of the first subset of the plurality of input data categories further comprises:
identifying a second subset of the plurality of input data categories, wherein the second subset of the plurality of input data categories includes each of the plurality of input data categories not in the first subset of the plurality of input data categories;
determining an average steepness β̅_̅{̅g̅}̅ of the regression curve equation for each of the second subset of the plurality of input data categories based at least in part on the regression curve equation of each of the second subset of the plurality of input data categories;
determining a constant factor α′ and a lower bound model loss γ′ of the one of the first subset of the plurality of input data categories based at least in part on the regression curve equation of the one of the first subset of the plurality of input data categories; and
determining the one of the plurality of data collection quotas using a predetermined equation based at least in part on the average steepness β̅_̅{̅g̅}̅, the constant factor α′ and the lower bound model loss γ′.

8. The method of claim 7, wherein determining the one of the plurality of data collection quotas using the predetermined equation further comprises:
determining the one of the plurality of data collection quotas using the predetermined equation, wherein the predetermined equation includes:
$${m}_{i + 1} = {[ \frac{0.5 ε ( {m}_{i} ) - {γ}^{′}}{{α}^{′}} ]}^{{( \overline{{β}_{g}} )}^{- 1}}$$
wherein mᵢ₊₁ is the one of the plurality of data collection quotas, mᵢ is a quantity of input data samples in the one of the first subset of the plurality of input data categories, α′ is a first constant factor of the one of the first subset of the plurality of input data categories, γ′ is a lower bound model loss of the one of the first subset of the plurality of input data categories, and β̅_̅{̅g̅}̅ is the average steepness of the regression curve equation for each of the second subset of the plurality of input data categories.

9. The method of claim 8, wherein collecting the second plurality of input data samples further comprises:
determining a quantity of additional input data samples to collect for each of the first subset of the plurality of input data categories using an equation:
$$s = {m}_{i + 1} - {m}_{i}$$
wherein s is the quantity of additional input data samples to collect for the one of the first subset of the plurality of input data categories, mᵢ₊₁ is the one of the plurality of data collection quotas for the one of the first subset of the plurality of input data categories, and mᵢ is the quantity of input data samples in the one of the first subset of the plurality of input data categories; and
transmitting a data sample collection task to a vehicle, wherein the data sample collection task includes at least the quantity of additional input data samples to collect for each of the first subset of the plurality of input data categories.

10. The method of claim 9, wherein training the machine learning algorithm using the second plurality of input data samples and the input data set further comprises:
receiving the second plurality of input data samples from the vehicle;
generating an updated input data set, wherein the updated input data set includes the second plurality of input data samples and the input data set; and
performing the method using the updated input data set.

11. A system for training a machine learning algorithm for a vehicle, the system comprising:
a server system including:
a server storage device;
a server communication system; and
a server controller in electrical communication with the server storage device and the server communication system, wherein the server controller is programmed to:
perform at least one exploratory training session of the machine learning algorithm using an input data set, wherein the input data set includes a first plurality of input data samples, and wherein the input data set is stored on the server storage device;
divide the input data set into a plurality of input data categories;
generate an exploratory learning curve plot of a model loss of the machine learning algorithm versus a quantity of input data samples trained for each of the plurality of input data categories in the at least one exploratory training session;
determine a regression curve equation for each of the plurality of input data categories based at least in part on the exploratory learning curve plot for each of the plurality of input data categories, wherein the regression curve equation for one of the plurality of input data categories is a power law equation having a form:
$$ε ( m ) = α {m}^{{β}_{g}} + γ$$
wherein ε is the model loss of the machine learning algorithm for the one of the plurality of input data categories, α is a first constant factor for the one of the plurality of input data categories, m is a quantity of input data samples trained for the one of the plurality of input data categories, β_{g} is a steepness of a regression curve described by the regression curve equation for the one of the plurality of input data categories, and γ is a lower bound model loss of the machine learning algorithm for the one of the plurality of input data categories;
collect a second plurality of input data samples from the vehicle using the server communication system, wherein the second plurality of input data samples is based at least in part on the regression curve equation for each of the plurality of input data categories; and
train the machine learning algorithm using the second plurality of input data samples and the input data set.

12. The system of claim 11, wherein to collect the second plurality of input data samples from the vehicle using the server communication system, the server controller is further programmed to:
identify a first subset of the plurality of input data categories based at least in part on a quantity of input data samples in each of the plurality of input data categories;
determine a plurality of data collection quotas based at least in part on the regression curve equation for each of the plurality of input data categories, wherein each of the plurality of data collection quotas corresponds to one of the first subset of the plurality of input data categories;
determine a quantity of additional input data samples to collect for each of the first subset of the plurality of input data categories using an equation:
$$s = {m}_{i + 1} - {m}_{i}$$
wherein s is the quantity of additional input data samples to collect for the one of the first subset of the plurality of input data categories, mᵢ₊₁ is the one of the plurality of data collection quotas for the one of the first subset of the plurality of input data categories, and mᵢ is a quantity of input data samples in the one of the first subset of the plurality of input data categories; and
transmit a data sample collection task to the vehicle using the server communication system, wherein the data sample collection task includes at least the quantity of additional input data samples to collect for each of the first subset of the plurality of input data categories.

13. The system of claim 12, wherein to determine one of the plurality of data collection quotas corresponding to one of the first subset of the plurality of input data categories, the server controller is further programmed to:
identify a second subset of the plurality of input data categories, wherein the second subset of the plurality of input data categories includes each of the plurality of input data categories not in the first subset of the plurality of input data categories;
determine an average steepness β̅_̅{̅g̅}̅ of the regression curve equation for each of the second subset of the plurality of input data categories based at least in part on the regression curve equation of each of the second subset of the plurality of input data categories;
determine a constant factor α′ and a lower bound model loss γ′ of the one of the first subset of the plurality of input data categories based at least in part on the regression curve equation of the one of the first subset of the plurality of input data categories; and
determine the one of the plurality of data collection quotas using a predetermined equation based at least in part on the average steepness β̅_̅{̅g̅}̅, the constant factor α′ and the lower bound model loss γ′.

14. The system of claim 13, wherein to determine the one of the plurality of data collection quotas using the predetermined equation, the server controller is further programmed to:
determine the one of the plurality of data collection quotas using the predetermined equation, wherein the predetermined equation includes:
$${m}_{i + 1} = {[ \frac{0.5 ε ( {m}_{i} ) - {γ}^{′}}{{α}^{′}} ]}^{{( \overline{{β}_{g}} )}^{- 1}}$$
wherein mᵢ₊₁ is the one of the plurality of data collection quotas, mᵢ is a quantity of input data samples in the one of the first subset of the plurality of input data categories, α′ is the constant factor of the one of the first subset of the plurality of input data categories, γ′ is the lower bound model loss of the one of the first subset of the plurality of input data categories, and β̅_̅{̅g̅}̅ is the average steepness of the regression curve equation for each of the second subset of the plurality of input data categories.

15. The system of claim 12, wherein to transmit the data sample collection task to the vehicle using the server communication system, the server controller is further programmed to:
transmit the data sample collection task to the vehicle using the server communication system, wherein the data sample collection task includes a validation algorithm describing one of the plurality of input data categories and at least one of: a task priority, a projected decrease in model loss, and the quantity of additional input data samples to collect.

16. The system of claim 15, further comprising a vehicle system including:
at least one vehicle sensor;
a vehicle communication system; and
a vehicle controller in electrical communication with the at least one vehicle sensor and the vehicle communication system, wherein the vehicle controller is programmed to:
receive the data sample collection task from the server system using the vehicle communication system;
determine a priority of the data sample collection task based at least in part on at least one of the task priority, the projected decrease in model loss, and the quantity of additional input data samples to collect; and
perform the data sample collection task using the at least one vehicle sensor.

17. The system of claim 16, wherein to perform the data sample collection task, the vehicle controller is further programmed to:
record a plurality of unvalidated input data samples using the at least one vehicle sensor;
determine a second plurality of input data samples based at least in part on the validation algorithm, wherein the second plurality of input data samples is a subset of the plurality of unvalidated input data samples; and
transmit the second plurality of input data samples to the server communication system using the vehicle communication system.

18. A method for training a machine learning algorithm for a vehicle, the method comprising:
performing at least one exploratory training session of the machine learning algorithm using an input data set, wherein the input data set includes a first plurality of input data samples, and wherein the input data set is stored on a server storage device;
dividing the input data set into a plurality of input data categories;
generating an exploratory learning curve plot of a model loss of the machine learning algorithm versus a quantity of input data samples trained for each of the plurality of input data categories in the at least one exploratory training session; and
determining a regression curve equation for each of the plurality of input data categories based at least in part on the exploratory learning curve plot for each of the plurality of input data categories, wherein the regression curve equation for one of the plurality of input data categories is a power law equation having a form:
$$ε ( m ) = α {m}^{{β}_{g}} + γ$$
wherein ε is the model loss of the machine learning algorithm for the one of the plurality of input data categories, α is a first constant factor for the one of the plurality of input data categories, m is a quantity of input data samples trained for the one of the plurality of input data categories, β_{g} is a steepness of a regression curve described by the regression curve equation for the one of the plurality of input data categories, and γ is a lower bound model loss of the machine learning algorithm for the one of the plurality of input data categories;
transmitting a data sample collection task to a vehicle communication system of the vehicle using a server communication system;
receiving the data sample collection task using a vehicle communication system;
collecting a second plurality of input data samples using at least one vehicle sensor, wherein the second plurality of input data samples is based at least in part on the regression curve equation for each of the plurality of input data categories;
transmitting the second plurality of input data samples from the vehicle communication system to the server communication system; and
training the machine learning algorithm using the second plurality of input data samples received from the vehicle communication system and the input data set.

19. The method of claim 18, wherein collecting the second plurality of input data samples from the vehicle using the server communication system further comprises:
identifying a first subset of the plurality of input data categories based at least in part on a quantity of input data samples in each of the plurality of input data categories;
determining a plurality of data collection quotas based at least in part on the regression curve equation for each of the plurality of input data categories, wherein each of the plurality of data collection quotas corresponds to one of the first subset of the plurality of input data categories;
determining a quantity of additional input data samples to collect for each of the first subset of the plurality of input data categories using an equation:
$$s = {m}_{i + 1} - {m}_{i}$$
wherein s is the quantity of additional input data samples to collect for the one of the first subset of the plurality of input data categories, mᵢ₊₁ is the one of the plurality of data collection quotas for the one of the first subset of the plurality of input data categories, and mᵢ is a quantity of input data samples in the one of the first subset of the plurality of input data categories; and
transmitting the data sample collection task to the vehicle communication system using the server communication system, wherein the data sample collection task includes at least the quantity of additional input data samples to collect for each of the first subset of the plurality of input data categories.

20. The method of claim 19, wherein determining one of the plurality of data collection quotas corresponding to one of the first subset of the plurality of input data categories further comprises:
identifying a second subset of the plurality of input data categories, wherein the second subset of the plurality of input data categories includes each of the plurality of input data categories not in the first subset of the plurality of input data categories;
determining an average steepness β̅_̅{̅g̅}̅ of the regression curve equation for each of the second subset of the plurality of input data categories based at least in part on the regression curve equation of each of the second subset of the plurality of input data categories;
determining a constant factor α′ and a lower bound model loss γ′ of the one of the first subset of the plurality of input data categories based at least in part on the regression curve equation of the one of the first subset of the plurality of input data categories; and
determining the one of the plurality of data collection quotas using a predetermined equation, wherein the predetermined equation includes:
$${m}_{i + 1} = {[ \frac{0.5 ε ( {m}_{i} ) - {γ}^{′}}{{α}^{′}} ]}^{{( \overline{{β}_{g}} )}^{- 1}}$$
wherein mᵢ₊₁ is the one of the plurality of data collection quotas, mᵢ is a quantity of input data samples in the one of the first subset of the plurality of input data categories, α′ is the constant factor of the one of the first subset of the plurality of input data categories, γ′ is the lower bound model loss of the one of the first subset of the plurality of input data categories, and β̅_̅{̅g̅}̅ is the average steepness of the regression curve equation for each of the second subset of the plurality of input data categories.
